(19) United States
(12) Patent Application Publication
(10) Pub. No.: US 2008/0121353 A1
(43) Pub. Date: May 29, 2008

(54) Manual roller shade having clutch mechanism, chain guide and universal mounting

(76) Inventors: Brandon J. Detmer, Spaulding, IL (US); Jason O. Adams, Emmaus, PA (US)

Correspondence Address: Drinker Biddle & Reath LLP, Patent Docketing, One Logan Square 18th and Cherry Streets, Philadelphia, PA, 19103-6996, US

(21) Appl. No.: 11/985,418

(22) Filed: Nov. 15, 2007

Related U.S. Application Data
(60) Provisional application No. 60/859,317, filed on Nov. 16, 2006.

(51) Int. Cl. E06B 9/58; F16H 57/08; E06B 9/68; E06B 9/56; F16D 67/02

(52) U.S. Cl. 160/266; 475/349; 192/12 R; 160/309; 160/311; 160/323.1

(57) ABSTRACT

A manual roller shade includes a clutch mechanism having a gear train transferring rotation of an input sprocket to rotation of an output member engaging a roller tube. The gear train includes a sun gear, planet gears supported by a carrier and engaging the sun gear, and a ring gear engaging the planet gears. According to one embodiment, the carrier does not rotate. The ratio between the diameters of the input sprocket and the roller tube is selected to offset mechanical advantage of the gear train to provide an effective gear train ratio of approximately 2:1. A drive chain guide system includes spaced guide wheels controlling where a drive chain is suspended from the manual shade. A roller shade mounting system includes a bracket receiving either an input assembly of the manual roller shade or a motor of a motorized roller shade to facilitate conversion.

### CROSS-REFERENCE TO RELATED APPLICATION

This application claims priority from U.S. provisional application No. 60/859,317, filed Nov. 16, 2006, the entire disclosure of which is hereby incorporated by reference.

### FIELD OF THE INVENTION

The present invention relates to manual roller shades.

### BACKGROUND

Roller shades include a flexible shade fabric windingly received on a roller tube for raising and lowering the shade fabric by rotating the roller tube. In manual roller shades, the rotation of the roller tube is provided by an input wheel that receives an input chain for converting a pulling force applied to the input chain into rotation of the input wheel. Manual roller shades include clutches having gear assemblies for transmitting the rotation of the input wheel to the rotation of the roller tube.

Roller shade installations sometimes include a top treatment (e.g., fascia) for concealing the roller tube from view. It is typically necessary to notch the fascia and/or redirect the chain as it drops from the input wheel to provide for passage of the chain beyond the fascia.

Traditionally, manufacturers of motorized roller shades do not manufacture manual roller shades, and vice versa. As a result, manual roller shades and motorized shades utilize different mounting hardware for installing the roller shades. As a result, upgrading in order to replace a manual roller shade with a motorized roller shade is rendered difficult and time consuming because incompatible mounting hardware of the manual roller shade must be replaced with, or supplemented by, mounting hardware adapted for the motorized roller shade.

### SUMMARY OF THE INVENTION

According to one aspect of the present invention, a clutch mechanism is provided for a manual roller shade having a roller tube adapted for winding receipt of a flexible shade fabric. The clutch mechanism comprises a rotatably supported sprocket adapted to receive a drive chain for rotation of the sprocket in response to application of an input force to the drive chain and an output member adapted for engagement with the roller tube. The clutch mechanism also comprises a gear train coupled between the sprocket and the output member for transmitting rotation of the sprocket to rotation of the output member. The gear train includes a sun gear, a plurality of planet gears rotatably mounted on a planet carrier and meshingly engaging the sun gear, and a ring gear meshingly engaging the planet gears. The sun gear and the ring gear rotate during actuation of the gear train while the planet carrier is held against rotation. The clutch mechanism is characterized by a sprocket ratio representing a ratio between the diameter of the sprocket and the diameter of the roller tube selected such that mechanical advantage of the gear train is offset to provide an effective gear ratio for the gear train of approximately 2:1.

According to one embodiment, the clutch mechanism includes a brake mechanism for preventing back-driving of the gear train by the output member. The brake mechanism includes a brake input engaged to the ring gear to rotate with the ring gear and at least one brake spring having a coiled body portion. The brake input includes a side opening and is adapted for receipt within an interior of the output member. The brake spring includes outwardly directed contact tangs at opposite ends of the coiled body portion adapted for receipt through the side opening of the brake input to locate the tang between an edge of the brake input and an inner surface of the output member.

According to another aspect of the invention, a chain guide system is provided for a manual roller shade having an input sprocket adapted to receive a drive chain for applying an input force to actuate the manual roller shade. The chain guide system comprises a plurality of rotatably supported chain guide wheels. The chain guide wheels are spaced from each other to receive the drive chain from the sprocket wheel and control where the drive chain drops from the manual roller shade.

According to one embodiment, the chain guide system includes three chain guide wheels arranged to receive the drive chain and control where the chain drops from the manual roller shade in any one of multiple angular orientations for the manual roller shade. The chain guide wheels include a rounded periphery defining a scalloped edge adapted to receive a drive chain having spaced beads.

According to another aspect of the invention, a roller shade mounting system is adapted for ease of upgrading a roller shade installation from a manual drive system to a motorized drive system. According to one embodiment, the system includes identical first and second brackets each adapted to receive any one of an idler end assembly, an input end of a manual roller shade, and a drive end of a motorized roller shade. The roller shade mounting system provides for upgrade of an installed manual roller shade simply by removing the manual drive system from the input end of the roller shade and by replacing the manual drive system with the motor of the motorized roller shade adapted for receipt by the bracket. Thus, all that is needed to accomplish the upgrade is the motor. The invention provides a completely shared system that includes brackets, roller tube, idler end assembly, fabric, hembar, fascia, top/back, pocket, flap, flap hanger, end-caps, etc. No modification is needed for any of these shared features.

The roller shade mounting system provides for a method of replacing a manual roller shade with a motorized roller shade (i.e., upgrading) by installing the first and second brackets at spaced locations at an installation site, mounting the manual roller shade at the installation site such that the input end and idler end assembly of the manual roller shade are respectively received by the first and second bracket, removing the manual roller shade from the first and second brackets, and mounting the motorized roller shade at the installation site such that the drive end and the idler end assembly of the motorized roller shade are respectively received by the first and second brackets.

### BRIEF DESCRIPTION OF THE DRAWINGS

For the purpose of illustrating the invention, the drawings show a form of the invention that is presently preferred. However, it should be understood that this invention is not limited to the precise arrangements and instrumentalities shown in the drawings.

FIG. 1 is a perspective view of a manual roller shade assembly including a clutch mechanism according to an exemplary embodiment of the invention.

FIG. 2 is an exploded perspective view of the manual roller shade assembly of FIG. 1.

FIG. 3 is a sectional view of a clutch mechanism of the manual roller shade assembly of FIG. 2.

FIG. 4 is an exploded perspective view of the clutch mechanism of FIG. 3.

FIG. 5 is an exploded perspective view of the clutch mechanism of FIG. 3 viewed from an opposite end of the clutch mechanism from the view shown in FIG. 4

FIG. 6 is an exploded perspective view of the clutch mechanism of FIG. 5 shown with planet gears received on a carrier mandrel of the clutch mechanism.

FIG. 7 is an end view of one of the brake springs of the clutch mechanism of FIGS. 4 through 6 from a point of view looking from a ring gear of the clutch mechanism in FIGS. 4 through 6 towards a carrier mandrel of the clutch mechanism.

FIG. 8 is a perspective view of the manual roller shade assembly of FIG. 1 shown supported from a location above the clutch mechanism.

FIG. 9 is a perspective view of the manual roller shade assembly of FIG. 8 shown without the end cover of the clutch mechanism and the support bracket.

FIG. 10 is a perspective view of the manual roller shade assembly of FIG. 1 shown supported from a location above the clutch mechanism and with the clutch mechanism rotated 90 degrees clockwise with respect to the clutch mechanism of FIG. 8.

FIG. 11 is a perspective view of the manual roller shade assembly of FIG. 10 shown without the end cover of the clutch mechanism and the support bracket.

FIG. 12 is a perspective view of the manual roller shade assembly of FIG. 1 shown supported from a location above the clutch mechanism and with the clutch mechanism rotated 90 degrees counter-clockwise with respect to the clutch mechanism of FIG. 8.

FIG. 13 is a perspective view of the manual roller shade assembly of FIG. 12 shown without the end cover of the clutch mechanism and the support bracket.

FIG. 14 is a perspective view of a motorized shade roller assembly adapted for support using the same support structure as the manual roller shade assembly of FIG. 1.

FIG. 15 is an exploded perspective view of the motorized roller shade assembly of FIG. 14.

FIG. 16 is a perspective view, partly in section, of the idler end of the manual roller shade assembly of FIG. 1.

FIG. 17 is a graph showing a curve of input force versus the gear ratio of a manual roller shade assembly and a curve of the ratio of chain travel to fabric travel versus the gear ratio of the manual roller shade assembly.

### DETAILED DESCRIPTION OF THE INVENTION

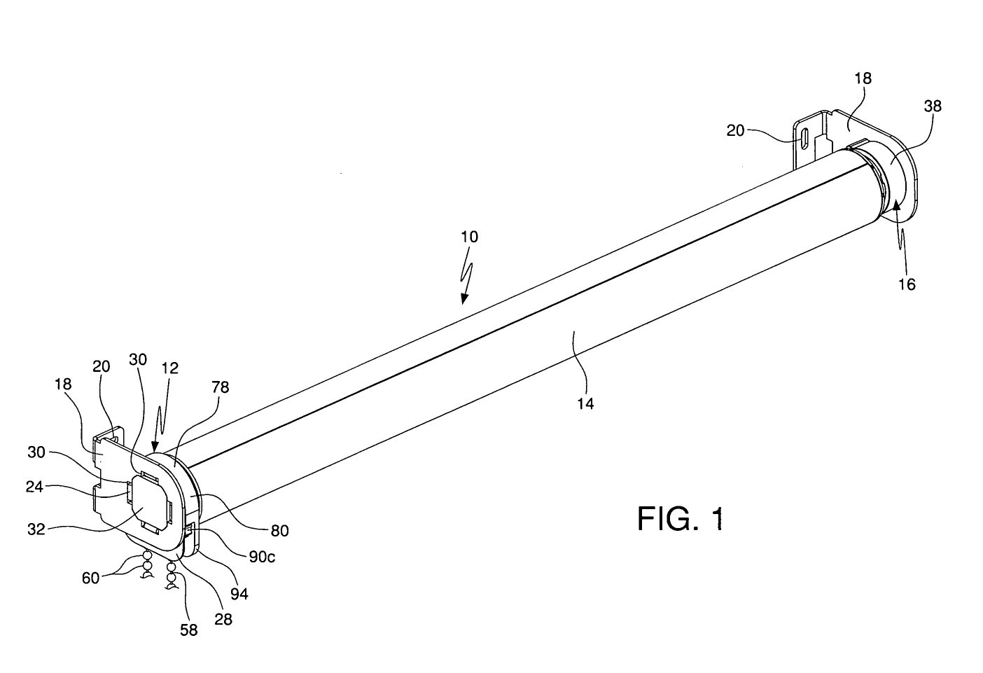

Referring to the drawings, where like numerals identify like elements, there is illustrated in FIG. 1 a manual roller shade 10 according to an exemplary embodiment of the invention including a clutch mechanism 12 that is bi-directional to provide for raising and lowering of a flexible shade fabric (not shown) windingly supported by an elongated roller tube 14 of the roller shade 10. The attachment of flexible shade fabrics to roller shade tubes is well known and no further description is required. As described below in greater detail, the clutch mechanism 12 is adapted to rotatingly drive the roller tube 14 of the roller shade 10 and to prevent back-driving of the roller tube 14 of the manual roller shade 10 that could otherwise occur, for example, if a pulling force was applied to a lower end of a flexible shade supported by the roller tube 14.

The clutch mechanism 12 is located adjacent a first end of the roller tube 14 on the left hand side of the view shown in FIG. 1. The roller shade 10 includes an idler assembly 16 located adjacent a second end of the roller tube 14 opposite the clutch mechanism 12. The idler assembly 16 provides rotatable support for the roller tube 14 at the second end of the roller tube 14. The roller shade 10 includes brackets 18 at opposite ends of the roller shade 10 for supporting the roller shade 10 from a fixed support surface such as a wall or ceiling of a structure, for example.

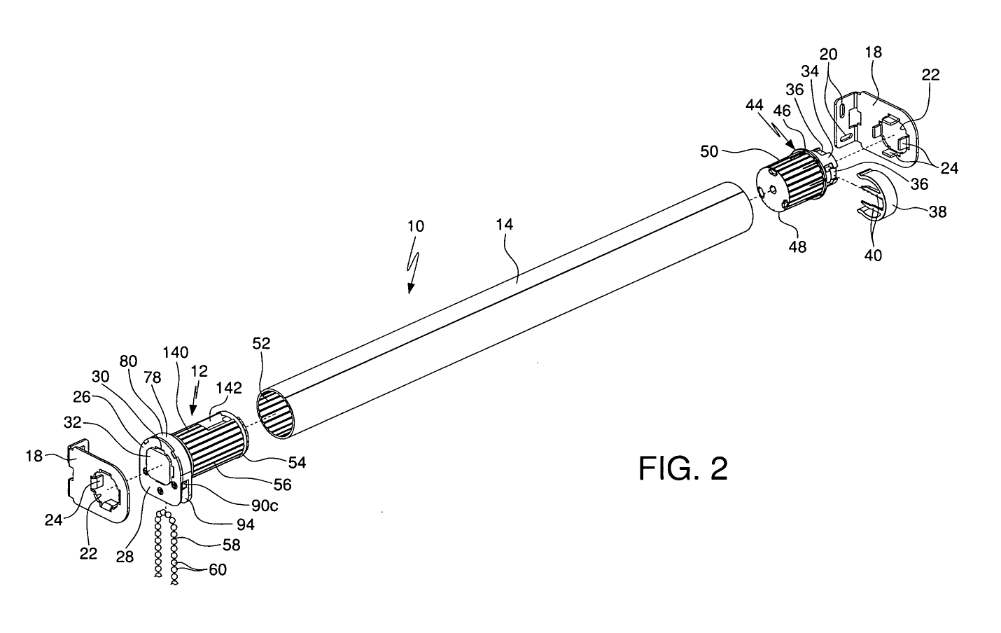

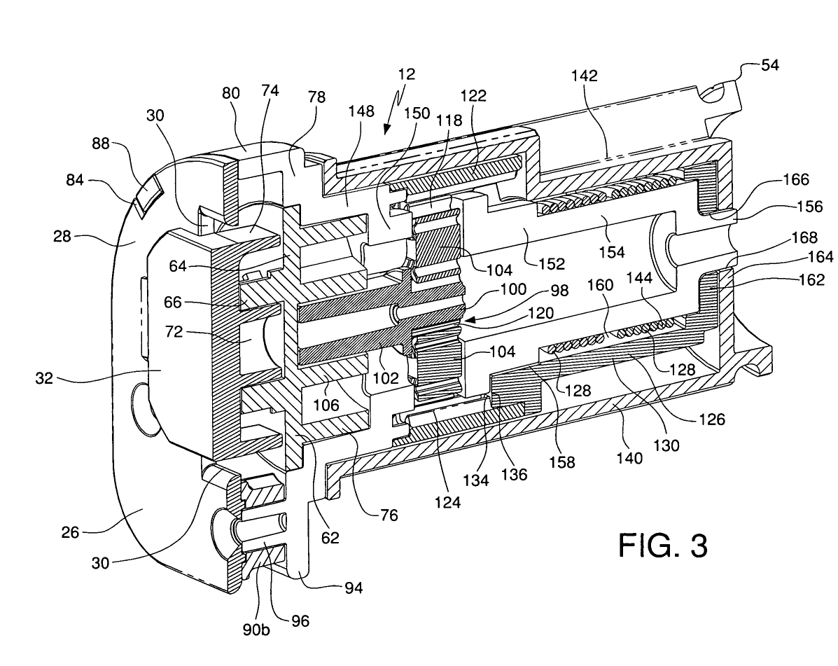

Referring to FIG. 2, the brackets 18 are identical to each other having a substantially L-shaped construction and defining openings 20 for receiving fasteners (e.g., screws) for securing the bracket 18 to a fixed support surface. The bracket 18 also includes an aperture 22 and tabs 24 located about the aperture 22 for coupling the bracket 18 to either the clutch mechanism 12 or the idler assembly 16. As shown in FIG. 2, the clutch mechanism 12 includes a back cover 26 having a plate 28 defining slot-like openings 30 for receiving the tabs 24 of the bracket 18. The openings 30 in the back cover plate 28 are located about a periphery of a bracket mount portion 32 of the clutch mechanism 12 that is shaped for receipt within the aperture 22 of the bracket 18. As shown in FIG. 3, the bracket mount portion 32 of the clutch mechanism is defined by a portion of the back cover 26 that protrudes with respect to the plate 28.

The idler assembly 16 of roller shade 10 includes a bracket mount portion 34 defining a periphery adapted for receipt within the aperture 22 of the bracket 18. The bracket mount portion 34 of the idler assembly 16 includes notches 36 spaced about its periphery for receiving the tabs 24 of the bracket 18. The idler assembly 16 includes a retaining clip 38 having a pair of prong-like elements 40 each arranged for receipt in an opening formed in the bracket mount portion 34 of the idler assembly 16.

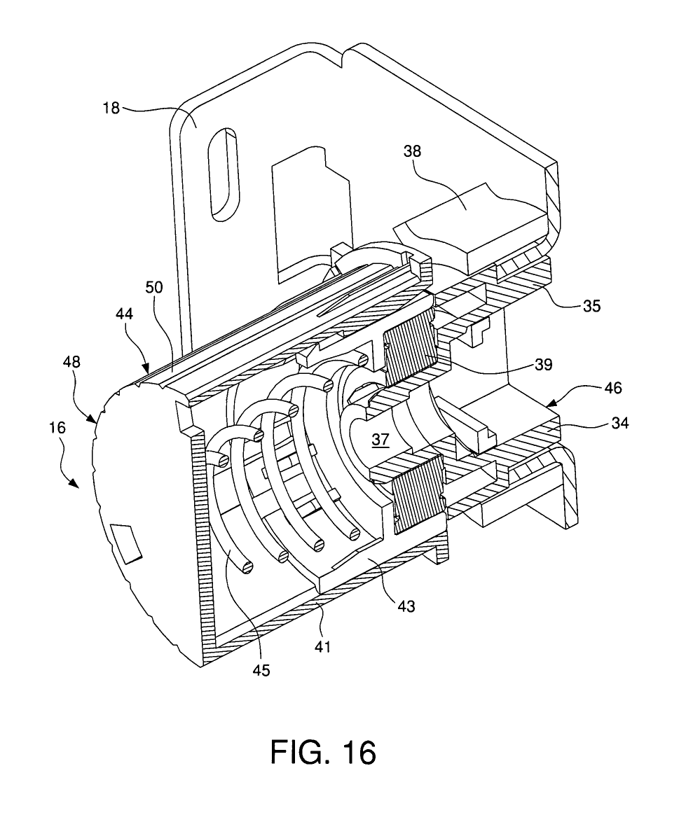

Referring to FIG. 16, the idler end of the manual roller shade 10 of FIGS. 1 and 2 is shown in greater detail. The idler assembly 16 includes a tube-end fitting 44 having inner and outer portions 46, 48 adapted for relative rotation therebetween. The inner portion 46 of the tube-end fitting 44 extends from the bracket mount portion 34 of the idler assembly 16 to rotatably support the outer portion 48 of the tube-end fitting 44 on the inner portion 46. The inner portion 46 includes an idler spring pin 35 that includes that above-described bracket mount portion 34 of the idler assembly 16 received by the bracket 18. The idler spring pin 35 includes a mount shaft 37 on which a ball bearing assembly 39 is rotatably received.

The outer portion 48 of the tube-end fitting 44 includes an idler bearing sleeve 41 defining a generally rounded periphery to provide for sliding receipt of the outer portion 48 within the open second end of the roller tube 14. The outer portion 48 also includes an idler slide 43 received in an open end of the idler bearing sleeve 41. As described below, the idler slide 43 is adapted to provide sliding movement of the idler bearing sleeve 41 with respect to the idler slide 43 to facilitate insertion of the manual roller shade 10 into the brackets 18.

The idler end assembly 16 includes a compression spring 45 within an interior of the idler bearing sleeve 41 having opposite ends respectively contacting the bearing sleeve 41 and the idler slide 43 for urging the bearing sleeve 41 away from the idler slide 43. This construction provides for relative axial movement between the bearing sleeve 41 and the idler spring pin 35 of the inner portion 46 as the spring 45 is compressed. The resulting shortening in the overall length of the manual roller shade 10 provided by the compression of the spring 45 facilitates insertion of the roller shade 10 into the bracket 18 as well as removal of the roller shade 10 from the brackets 18. As shown, the receipt of the retaining clip 38 by the idler spring pin 35 positions the retaining clip 38 between the bracket 18 and the idler bearing sleeve 41. As should be understood, the retaining clip 38 functions to limit the compression of the spring 45, thereby preventing inadvertent separation between the manual roller shade 10 and the brackets 18.

As shown, the idler bearing sleeve 41 of the tube-end fitting 44 defines elongated formations 50 spaced about its periphery for engaging receipt by corresponding formations 52 defined on an inner surface of the roller tube 14. In the front perspective view shown in FIG. 2, the interior of the roller tube 14 that is adjacent the second end of the roller tube 14 is not seen. However, it should be understood that the roller tube 14 includes inner surface formations adjacent the second end of roller tube 14 preferably similar to the formations 52 adjacent the first end of the roller tube 14, which are seen in the front perspective view of FIG. 1. The engagement between the corresponding formations 52, 50, respectively, of the roller tube 14 and the outer portion 48 of the tube-end fitting 44 facilitate transfer of rotation between the roller tube 14 to the idler assembly 16.

Referring to FIG. 1, the clutch mechanism 12 includes an output cover 54 defining a generally rounded periphery for sliding receipt within the first end of the roller tube 14. The output cover 54 of clutch mechanism 12 includes elongated formations 56 spaced about the periphery of the output cover 54. In a similar fashion as the formations 50 on the tube-end fitting 44 of the idler assembly 16, the formations 56 on the output cover 54 are arranged for engagement with the corresponding formations 52 formed on the inner surface of the roller tube 14 to facilitate transfer of rotation between the output cover 54 and the roller tube 14.

The manual roller shade 10 includes a elongated drive chain 58 having substantially spherical beads 60 spaced along the length of the drive chain 58. As shown in FIG. 1, the drive chain 58 is received by the clutch mechanism 12 such that oppositely located portions of the drive chain 58 hang from the clutch mechanism 12. To facilitate illustration, only a portion of the drive chain 58 has been shown in FIG. 1, it being understood that the overall length of the drive chain 58 is selected to provide for a sufficient number of rotations of the associated roller tube 14 for raising or lowering a shade fabric windingly supported by the roller tube 14 when pulling force is applied to one end of the drive chain 58. In known manner, the drive chain 58 could include a joint piece for linking opposite ends of the drive chain 58 to each other. Such a joint piece is typically not adapted for passage about the input wheel (i.e., in the manner of a continuous loop). It is conceivable, however, that the drive chain 58 could be constructed to function as an endless loop.

Arranged in this manner, each of the opposite hanging portions of the drive chain 58 is graspable by a user such that a pulling force can be applied to the hanging portion for drivingly rotating the roller tube 14 to either wind or unwind the shade fabric depending on which direction the roller tube 14 is rotated. The clutch mechanism 12 is adapted for bi-directional operation such that the associated roller tube 14 can be rotated in opposite directions by the clutch mechanism 12, to respectively wind and unwind a shade fabric secured to the roller tube 14, depending on which of the hanging portions of the drive chain 58 is pulled.

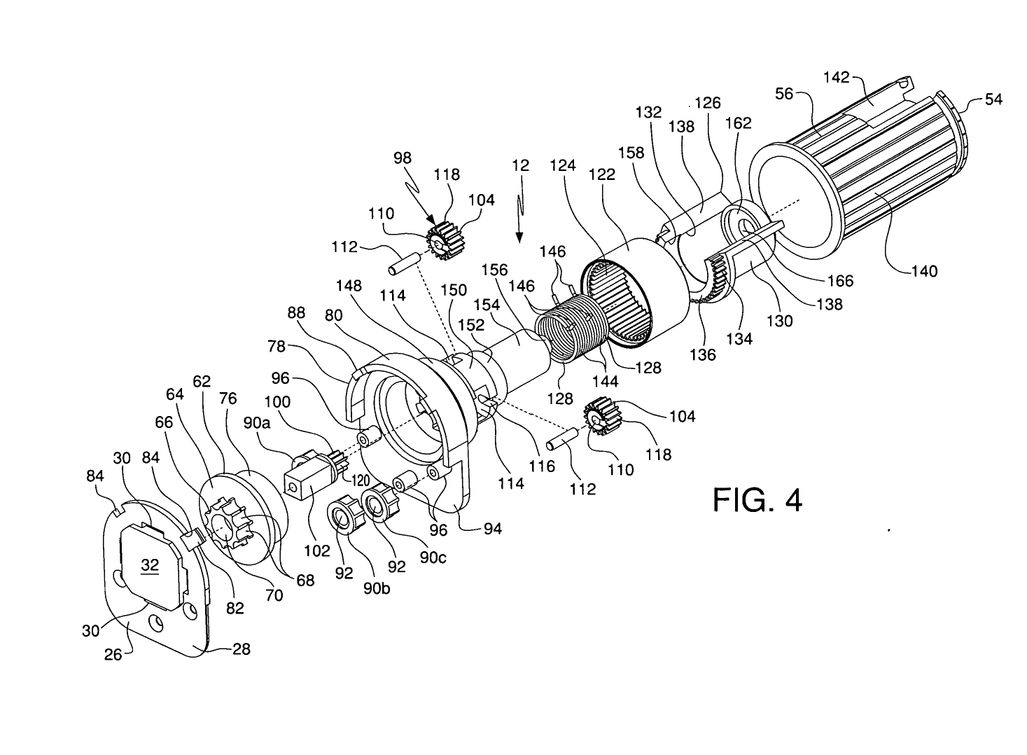

Referring to the sectional view of FIG. 3 and the exploded views of FIGS. 4-6, the clutch mechanism 12 is shown in greater detail. The clutch mechanism 12 includes an input wheel 62 rotatingly driven by the drive chain 58. As shown in FIG. 4, the input wheel 62 includes a disk 64 and a drive chain sprocket 66 centrally disposed on a first side of the disk 64. The drive chain sprocket 66 includes rounded bead notches 68 spaced about the periphery of the sprocket 66 for receiving the beads 60 of the drive chain 58. The receipt of the drive chain beads 60 in the bead notches 68 facilitates transfer of a pulling force applied to the drive chain 58 to the drive chain sprocket 66 for rotating the input wheel 62 about a rotational axis of the input wheel 62. The drive chain sprocket 66 defines a central aperture 70 adapted for receipt of a cylindrical support post 72 for rotatable support of the input wheel. As shown in FIG. 3, the support post 72 is located on the inner side of the back cover 26 opposite the bracket mounting portion 32.

The back cover 26 includes a drive chain rail 74 extending substantially in semi-cylindrical fashion about an upper half of the support post 72. The drive chain 58 is received by the drive chain sprocket 66 in a space defined between the drive chain sprocket 66 and the drive chain rail 74. Arranged in this manner, the drive chain rail 74 contains the drive chain 58 within the defined space for maintained engagement between the drive chain 58 and the drive chain sprocket 66. As shown in the sectional view of FIG. 3, the periphery of disk 64 is dimensioned such that the space defined between the drive chain sprocket 66 and the drive chain rail 74 is enclosed by the disk 64.

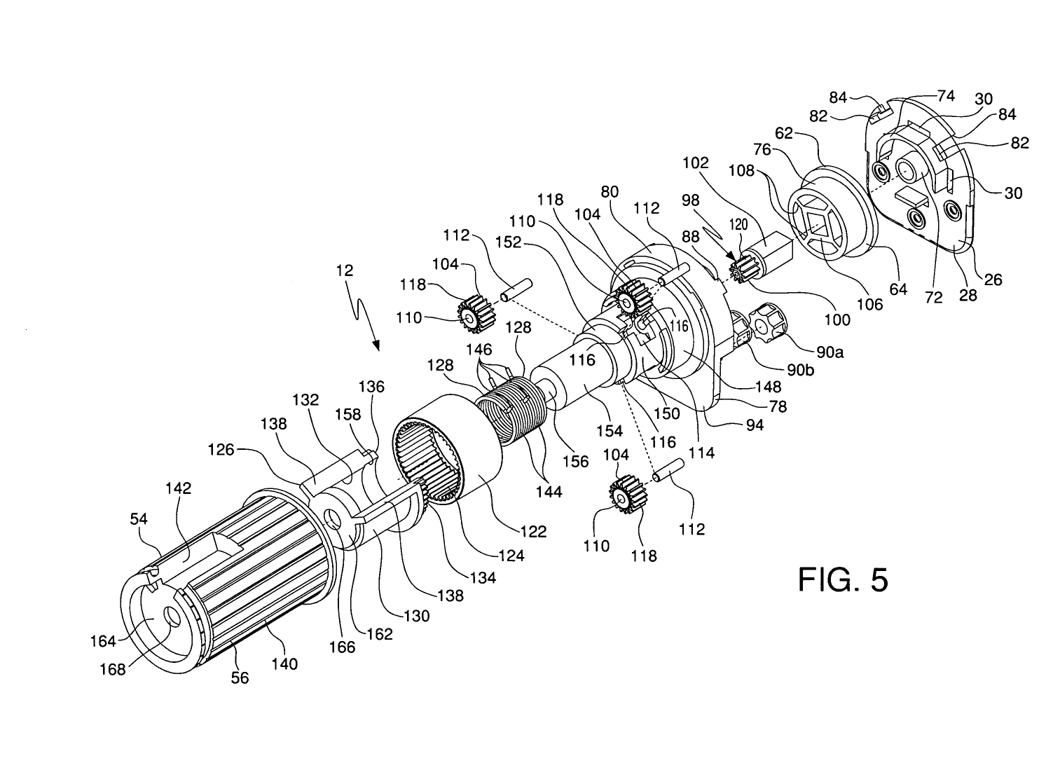

The input wheel 62 includes a cylinder 76 extending from a surface of the disk 64 opposite the drive chain sprocket 66. The clutch mechanism 12 includes a carrier mandrel 78 defining an interior receiving the input wheel cylinder 76. The interior of the carrier mandrel 78 and the input wheel cylinder 76 are dimensioned to provide for a sliding interfit such that the input wheel 62 is rotatable with respect to the carrier mandrel 78. The carrier mandrel 78 includes a peripheral flange 80 extending about an upper portion of the carrier mandrel 78. As shown in FIG. 5, the back cover 26 includes a pair of prongs 82 each located at a peripheral notch 84 formed in the back cover plate 28. The prongs 82 are received in openings 86 defined by the carrier mandrel 78 to provide for a snap-like engagement between the carrier mandrel flange 80 and a terminal portion of the prongs 82. The carrier mandrel 78 includes tabs 88 extending from the flange 80 for receipt within the peripheral notches 84 in the back cover plate 28 as shown in FIG. 3.

The clutch mechanism 12 includes a set of three chain guide wheels 90a, 90b, 90c. The chain guide wheels 90a, 90b, 90c define central apertures 92 for rotatably mounting the guide wheels 90a, 90b, 90c on support posts 96 located on a plate portion 94 of the carrier mandrel 78. As described below in greater detail, the chain guide wheels 90a, 90b, 90c are adapted to receive the drive chain 58 in multiple rotational orientations of the clutch mechanism 12 and to control the manner in which lower end portions of the drive chain 58 are suspended from the clutch mechanism 12. As shown, the periphery of the chain guide wheels 90a, 90b, 90c are rounded and scalloped to facilitate a nested engagement between the guide wheels and the beads 60 of drive chain 58. The construction of the guide wheels desirably reduces noise and reduces the required input force that must be applied to the chain by reducing drag forces.

The clutch mechanism 12 includes a gear assembly 98 having a sun gear 100 disposed at an end of a sun gear shaft 102 and a set of three planet gears 104. The sun gear shaft 102 is received by a support sleeve 106 carried by the input wheel 62 within an interior of the input wheel cylinder 76. The input wheel 62 includes a plurality of reinforcing ribs 108 interconnecting the support sleeve 106 and the input wheel cylinder 76. The support sleeve 106 is centrally disposed within the input wheel cylinder 76 such that a central axis of the sun gear 100 is substantially aligned with the rotational axis of the drive chain sprocket 66.

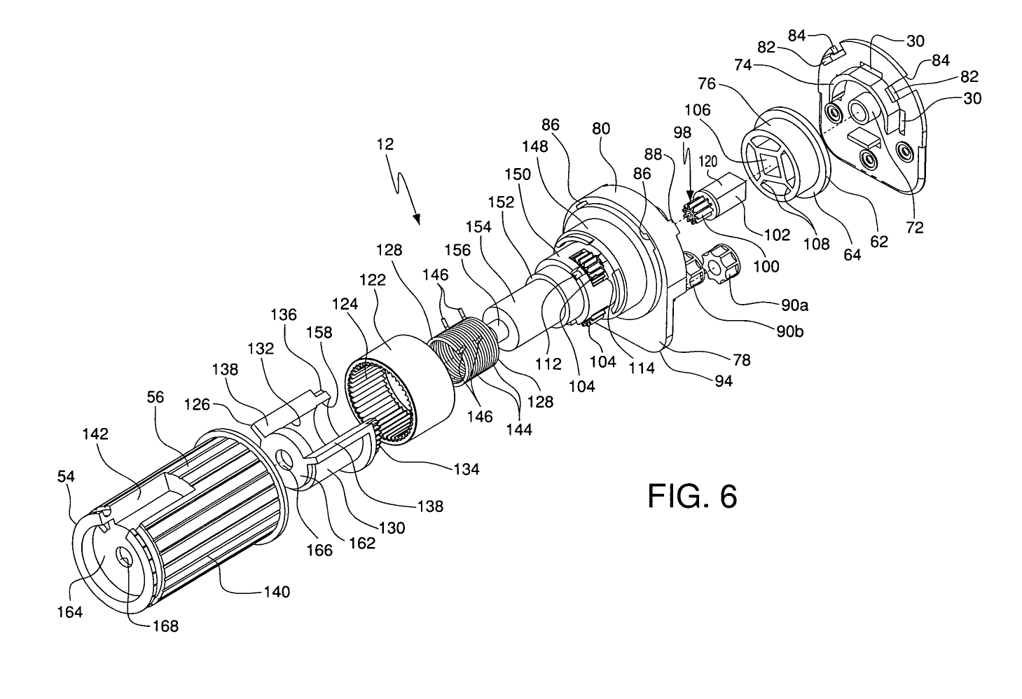

As shown in FIGS. 5 and 6, the sun gear shaft 102 and the support sleeve 106 define correspondingly square cross-sections. This promotes torque-transmission between the sun gear shaft 102 and support sleeve 106 to ensure that rotation of the input wheel 62 results in a corresponding rotation of the sun gear 100. It is not required that the cross sections be square. Other non-round configurations could be used such as hexagonal, for example. Also, it is conceivable that the sun gear shaft 102 and support sleeve 106 have generally rounded cross-sections including one or more faceted surfaces to provide for the desired torque-transmission between the shaft 102 and the sleeve 106.

Each of the planet gears 104 of gear assembly 98 is rotatably mounted to the carrier mandrel 78 for rotation of the planet gear 104 about a central axis of the planet gear 104. As shown, each planet gear 104 includes a central aperture 110 receiving an axle pin 112. The carrier mandrel 78 defines openings 114 adapted for receiving the planet gears 104. The axle pins 112 at received at opposite ends of the axle pins 112 in axle notches 116 located on opposite sides of the openings 114 such that the planet gears 104 communicate with both the interior and exterior of the carrier mandrel 78.

As illustrated in FIG. 3, the planet gears 104 have peripheral teeth 118 meshingly engaging teeth 120 of the sun gear 100 within the interior of the carrier mandrel 78. Arranged in this manner, the rotation of the input wheel 62 by pulling force applied to the drive chain 58 causes rotation of the sun gear 100 and the planet gears 104. As should be understood, the planet gears 104 rotate about their respective central axes but do not revolve around the sun gear 100 because of the pin connection between the planet gears 104 and the carrier mandrel 78.

The gear assembly 98 of the clutch mechanism 12 also includes a ring gear 122 having a substantially cylindrical body and elongated teeth 124 defined on an inner surface of the body. The ring gear 122 is received onto the exterior of the carrier mandrel 78 such that the ring gear teeth 124 meshingly engage the teeth 118 of the planet gears 104 mounted in the openings 114 in the carrier mandrel 78. The ring gear 122 is coupled to the output cover 54 by a brake input 126 and brake springs 128, as described below, such that rotation of the ring gear 122 results in rotation of the output cover 54. Arranged in this manner, the gear assembly 98 provides a drive train for the clutch mechanism 12 that functions to convert pulling force applied to the drive chain 58 into rotation of the output cover 54, thereby rotating the roller tube 14. As described in greater detail below, the brake input 126 and brake springs 128 are adapted to prevent the output cover 54 from back-driving the gear assembly 98 of the clutch mechanism 12 through the application of pulling force to a shade fabric windingly supported by the roller tube 14, for example.

The brake input 126 includes a semi-cylindrical wall 130 defining a side opening 132 and peripheral teeth 134 spaced about the wall 130 at an end 136 of the brake input 126. The brake input end 136 is received by the ring gear 122 such that the brake input teeth 134 meshingly engage the ring gear teeth 124 for simultaneous rotation of the brake input 126 with the ring gear 122.

The brake input 126 includes longitudinal flanges 138 extending along the wall 130 along each of opposite sides of the opening 132. The wall 130 and flanges 138 of the brake input 126 are dimensioned such that the brake input 126 is receivable within an interior defined by the output cover 54. The output cover 54 has a substantially cylindrical wall 140 including a trough-like indentation 142. The indentation 142 is dimensioned such that the brake input flanges 138 extend adjacent inwardly projecting portions of the inner surface of the output cover 54 defined on opposite sides of the indentation 142. Clearance is provided, however, between the brake input flanges 138 and the output cover indentation 142 to accommodate the brake springs 128 as follows.

Each of the brake springs 128 is coiled to form a substantially cylindrical body 144 having opposite ends. Each of the brake springs 128 also includes outwardly deflected portions at each of the opposite ends of the body 144 forming a tang 146. As should be understood, application of transverse forces to the tangs 146 of the brake spring 128 will tend to expand or contract the diameter of the intermediately located coiled body 144 depending on the direction in which force is applied to the tang 146 (i.e., inwardly directed forces for contraction of the coiled body 144 and outwardly directed forces for expansion).

The springs 128 are dimensioned such that the spring body 144 is receivable within an interior of the brake input 126 with the tangs 146 extending outwardly into the side opening 132 in the wall 130 of the brake input 126. The above-described clearance between the brake input 126 and the output cover 54 provides for receipt of the spring tangs 146 between the brake input flanges 138 and the inner surface of the output cover 54 defined by the indentation 142.

The exterior of carrier mandrel 78 includes substantially cylindrical surface portions 148, 150, 152, 154, 156 that decrease in diameter between surface portion 148 and surface portion 156. As shown in FIG. 3, the output cover 54 and ring gear 122 are telescopingly received on surface portions 148 and 150, respectively, of the carrier mandrel 78. A notch 158 is provided on the inner surface of brake input 126 at the end of the brake input 126 defining the peripheral teeth 134. As shown, the notch 158 provides an enlarged inner diameter for telescoping receipt of the brake input 126 onto surface portion 152 of the carrier mandrel 78. The body 144 of each spring 128 is dimensioned to provide for receipt of the spring body 144 onto surface portion 154 of the carrier mandrel 78. The body 144 of each spring 128 is received onto carrier mandrel surface portion 154 such that the body 144 is located in a semi-annular space 160 defined between the carrier mandrel 78 and the brake input wall 130.

The brake input 126 includes a transverse end wall 162 located at an end of the brake input 126 opposite end 136 defining teeth 134. The output cover 54 also includes a transverse wall 164 adjacent an end of the output cover 54. The transverse walls 162, 164 of the brake input 126 and the output cover 54 respectively include central apertures 166, 168. As shown in FIG. 3, the surface portion 156 of carrier mandrel 78 is received by the central apertures 166, 168 of the brake input 126 and output cover 54. The receipt of surface portion 156 by the openings 166, 168 serves to maintain the brake input 126 and output cover 54 in the substantially concentric alignment shown in FIG. 3.

As a result of the above-described location of the brake spring tangs 146 between the brake input flanges 138 and the output cover indentation 142, the brake springs 128 function to enable relative rotation between the output cover 54 and the carrier mandrel 78 when the clutch mechanism 12 is actuated by a user. The brake springs 128 also function to prevent the output cover 54 from rotating on the carrier mandrel 78 when torque is, instead, first applied to the output cover 54 (e.g., from a pulling force applied to a shade fabric windingly supported by the roller tube 14). As described below, the operation of the brake springs 128 is bi-directional such that relative rotation of the output cover 54 is enabled or prevented, respectively, regardless of which rotational direction the brake input 126 is driven by the clutch mechanism or which rotational direction a back-driving torque is applied to the output cover 54.

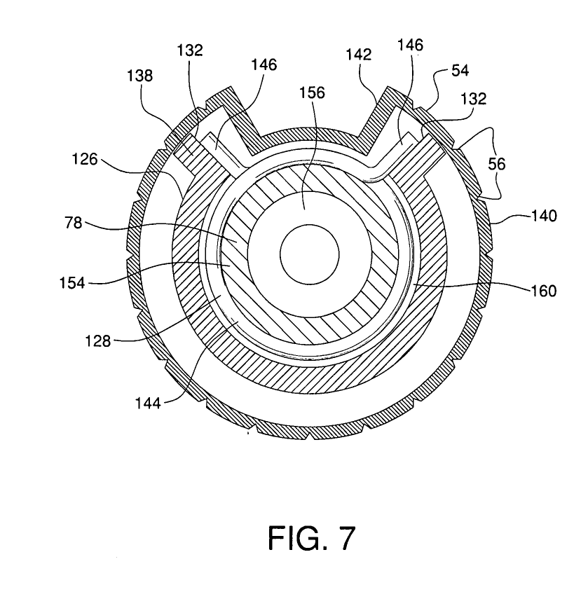

Referring to the end view of FIG. 7, one of the brake springs 128 is shown from an outwardly directed point of view with respect to roller shade 10 (i.e., looking from the ring gear 122 towards the carrier mandrel 78 in FIGS. 4-6). To facilitate description, the indentation 142 of the output cover 54 and the flanges 138 of the brake input 126 are shown schematically in FIG. 7. As described above, when the clutch mechanism 12 of roller shade 10 is actuated by a user applying a pulling force to one of the opposite ends of drive chain 58, the brake input 126 is rotated by the gear assembly 98 because of the engagement between the brake input 126 and the ring gear 122. A counter-clockwise rotation of the brake input 126 (from the point of view in FIG. 7) will cause the brake input flange 138 located on the right-hand side of the view to be brought into contact with the front tang 146 (i.e., the tang 146 closest the viewer). As should be understood, the brake spring 128 is arranged such that the contact between the right-hand flange 138 and the front tang 146 will tend to enlarge the diameter of the coiled body 144 of spring 128. Such enlargement in the diameter of the brake spring 128 releases the brake spring 128 from surface portion 154 of carrier mandrel 78 for rotation of the brake input 126 and brake springs 128 on the carrier mandrel 78. The rotation of the brake input 126 and brake springs 128 on the carrier mandrel 78 drivingly rotates the output cover 54 on the carrier mandrel 78 because of the intermediate location of the output cover indentation 142 between the brake input flanges 138.

A clockwise rotation of the brake input 126 in FIG. 7 from application of pulling force to an opposite end of the drive chain 58 brings the left-hand flange 138 of brake input 126 into contact with the rear tang 146. The brake springs 128 are arranged such that this contact, in a similar manner as the above-described contact during counter-clockwise rotation of the brake spring 128, will also tend to enlarge the diameter of the brake spring bodies 144. Thus, the operation of the brake input 126 and brake springs 128 is bi-directional in that the brake springs 128 are released for rotation on the carrier mandrel 78 regardless of the rotational direction in which the brake input 126 is rotated by the clutch mechanism 12.

The brake input 126 and brake springs 128 function to prevent the output cover 54 from back-driving the clutch mechanism 12 as follows. Referring still to FIG. 7, a clockwise rotation of the output cover 54 resulting from torque applied to the roller tube 14 will cause the output cover indentation 142 to be moved into contact with the front tang 146 of the brake spring 128. The output cover indentation 142 contacts the front tang 146 of the brake spring 128 from a side of the tang 146 opposite that contacted by the brake input flange 138 during the above-described actuation of the clutch mechanism. As should be understood, such contact with the front tang 146 causes reduction in the diameter of the brake spring body 144 such that compressive force between the brake spring body 144 and the surface portion 154 of carrier mandrel 78 frictionally locks the brake spring 128 against rotation with respect to the carrier mandrel 78. The frictional locking of the brake spring 128 to the carrier mandrel 78 in this manner functions to prevent the output cover 54 from rotating on the carrier mandrel 78 because of the location of the tangs 146, thereby preventing the output cover 54 from back-driving the brake input 126.

The back-driving prevention feature provided by the brake springs 128 is also bi-directional. Still referring to FIG. 7, a counter-clockwise rotation of the output cover 54 causes the output cover indentation 142 to contact the rear tang 146 of spring 128 such that the diameter of the spring body 144 is reduced. Therefore, in a similar manner as the above-described contact between the output cover indentation 142 and the front tang 146 during a clockwise rotation of the output cover 54, the contact between the indentation 142 and the rear tang 146 during counter-clockwise rotation of the output cover 54 frictionally locks the brake spring 128 onto the surface portion 154 of carrier mandrel 78.

### Chain Guide System

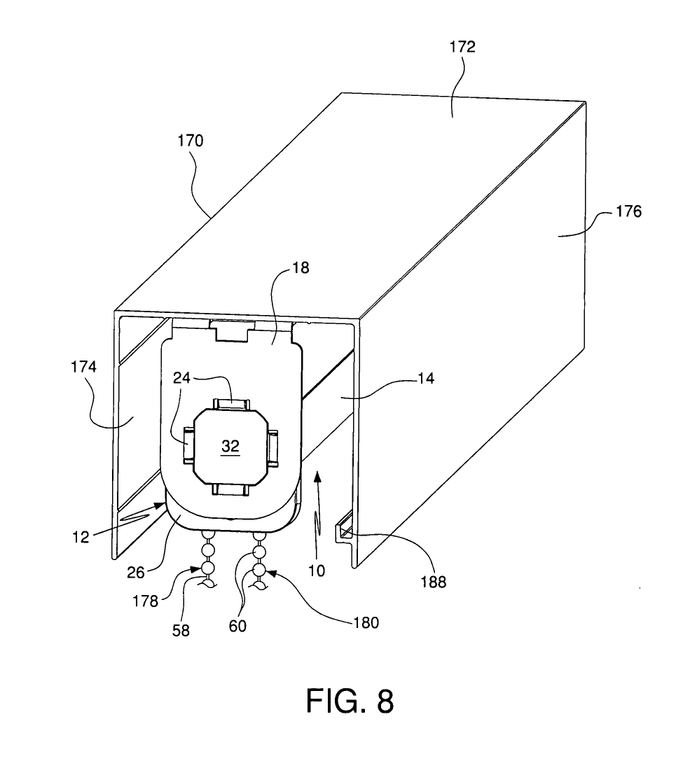

As described above, the clutch mechanism 12 includes a set of three drive chain guide wheels 90a, 90b, 90c for controlling the manner in which the drive chain 58 hangs from the clutch mechanism 12. Referring to FIGS. 8 through 13, the manual roller shade 10 is shown secured to a mounting channel 170 having a top wall 172 and a pair of opposite side walls 174, 176 to illustrate how the drive chain guide wheels 90a, 90b, 90c can be used to control the manner in which first and second portions 178, 180 of the drive chain 58 hang from the clutch mechanism 12. The brackets 18 of the manual roller shade 10 are oriented for securing the brackets 18 to the top wall 172 of the mounting channel 170 using fasteners (not shown). Although the depicted mounting channel is adapted as a ceiling mount, it should be understood that the invention is not so limited. The invention is applicable for any mounting configuration such as wall mounted and jamb-mounted brackets for example.

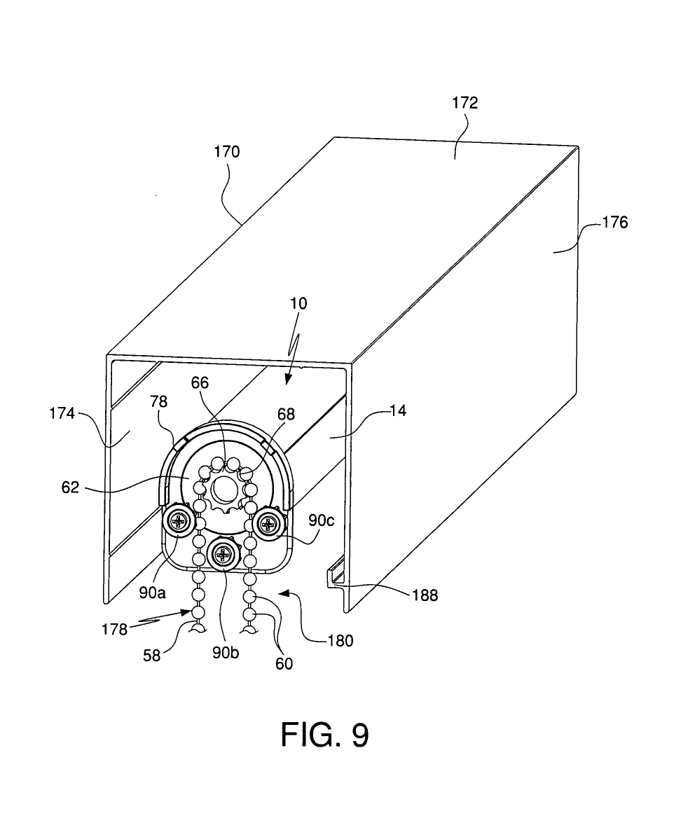

The construction of the manual roller shade 10 is adapted to provide multiple orientations for installing the roller shade 10 using the same brackets 18, thereby providing a universal mounting system. Referring first to FIGS. 8 and 9, the manual roller shade 10 is shown secured to the brackets 18 and the top wall 172 of mounting channel 170 in a first mounting configuration. The back cover 26 of the clutch mechanism 12 and the associated bracket 18 are removed in FIG. 9 to facilitate illustration of the drive chain guide wheels 90a, 90b, 90c and the interaction between the guide wheels 90a, 90b, 90c and the drive chain 58. As shown, the manual roller shade 10 is oriented with respect to the mounting channel 170 in the first mounting configuration such that beads 60 of drive chain 58 engage the sprocket 66 about an upper half of the sprocket 66 (from the point of view shown in FIG. 9). As a result, the first hanging portion 178 of drive chain 58 drops downwardly from the sprocket 66 between guide wheels 90a and 90b and the second hanging portion 180 of drive chain 58 drops downwardly from the sprocket 66 between guide wheels 90b and 90c.

As shown, the guiding interaction between the drive chain 58 and the drive chain guide wheels 90a, 90b, 90c is limited in the first mounting configuration because the hanging portions 178, 180 of drive chain 58 hang straight from the sprocket 66 between the above-mentioned pairs of the guide wheels 90a, 90b, 90c. As should be understood, however, the hanging portions 178, 180 of the drive chain 58 might be brought into contact with one of the guide wheels 90a, 90b, 90c during actuation of the clutch mechanism 12 in the event a user grasps and pulls one of the hanging portions 178, 180 at an angle instead of in the substantially vertical orientation shown. For example, if a user grasps drive chain portion 178 and raises it to the left (from the point of view shown in FIG. 9), the drive chain portion 178 would be brought into contact with guide wheel 90a. Thus, the guide wheels 90a, 90b, 90c function to keep the loading applied to the drive chain 58 by a user tangential to the sprocket 66. As will be shown, this feature is provided by the guide wheels 90a, 90b, 90c in any orientation. This desirably reduces the input force required to create the same torque, reduces drag from radial loading and keeps more of the beads 60 engaged in the notches 68 of sprocket wheel 66, thereby improving strength. The guide wheels 90a, 90b, 90c also prevent the chain 58 from contacting and rubbing against a stationary surface if the chain 58 is pulled at an angle, which is typically a source of increased noise and drag in conventional clutches. The relative locations of the hanging portions 178, 180 of drive chain 58 between the guide wheels 90a, 90b, 90c in the first mounting configuration will function to keep the beads 60 of drive chain 58 in engagement with the bead notches 68 of sprocket 66 as shown.

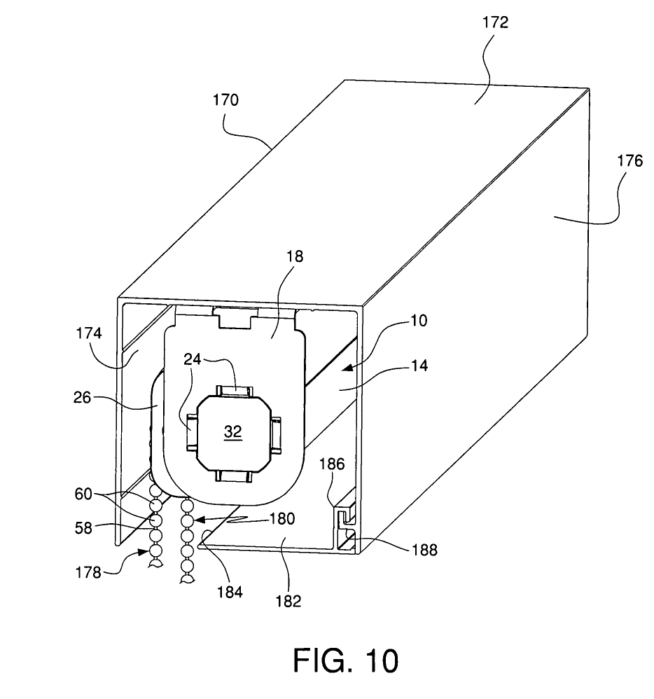

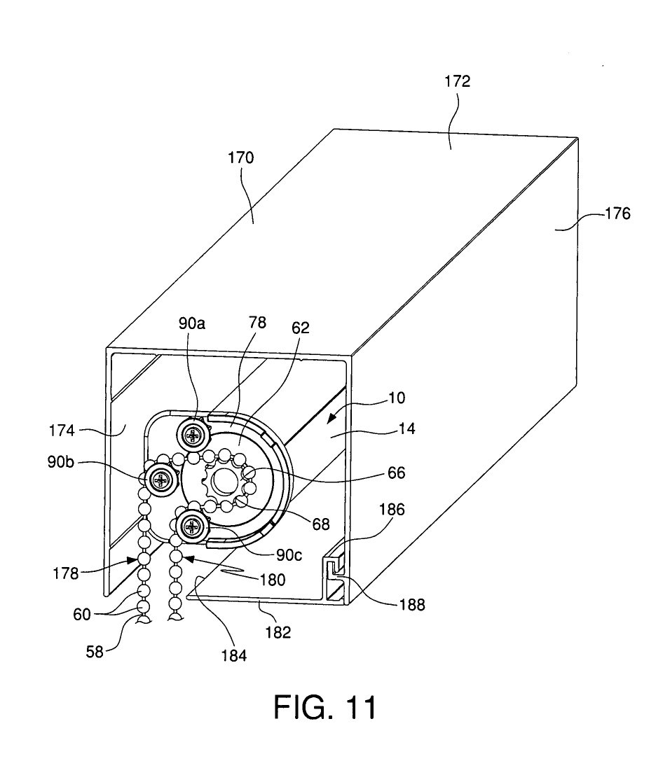

Referring first to FIGS. 10 and 11, the manual roller shade 10 is shown secured to the brackets 18 and the top wall 172 of mounting channel 170 in a second mounting configuration. As shown, the manual roller shade 10 is attached to the brackets 18 in FIGS. 10 and 11 such that the shade 10 is rotated ninety degrees in a clockwise direction in the second mounting configuration from the orientation of the shade 10 in the first mounting configuration of FIGS. 8 and 9. The mounting channel 170 includes a bottom panel 182 supported by side wall 176 to extend from side wall 176 towards side wall 174 such that a narrowed opening 184 is defined between an edge of the bottom panel 182 and side wall 174. The bottom panel 182, and the resulting narrowing of the opening along the bottom of the mounting channel 170 functions to conceal the manual roller shade 10 from view within the interior defined by the mounting channel 170.

The bottom panel 182 includes a support flange 186 extending longitudinally along the bottom panel 182. As shown, the support flange 186 is returned along a terminal edge portion of the support flange 186 such that the cross-section of the support flange 186 is substantially in the shape of an inverted J (from the point of view of FIG. 10). The mounting channel 170 includes a substantially L-shaped flange 188 located on side wall 176. As shown, the J-shaped support flange 186 of bottom panel 182 is received by the L-shaped flange 188 on the side wall 176 to support the bottom panel 182 from the side wall 176.

Referring to FIG. 11, the drive chain 58 interacts with the guide wheels 90a, 90b, 90c, in particular guide wheels 90b and 90c in the second mounting configuration to direct the drive chain 58 such that the first and second hanging portions 178, 180 drop from the guide wheels 90a, 90b, 90c through the narrowed opening 184 defined between the edge of the bottom panel 182 and the side wall 174. As shown, the beads 60 of the drive chain 58 in the second mounting configuration engage the sprocket 66 about a right-hand side of the sprocket 66 (from the point of view shown in FIG. 11). As also shown, the drive chain 58 is directed laterally from the sprocket 66 from both the top and the bottom of the sprocket 66 towards side wall 174. The drive chain 58 is directed about each of the guide wheels 90b and 90c such that the beads 60 of the drive chain 58 engage the outer periphery of the guide wheels 90b and 90c and the first and second hanging portions 178, 180 of the drive chain 58 hang downwardly from the guide wheels 90b and 90c, respectively, through the narrowed opening 184.

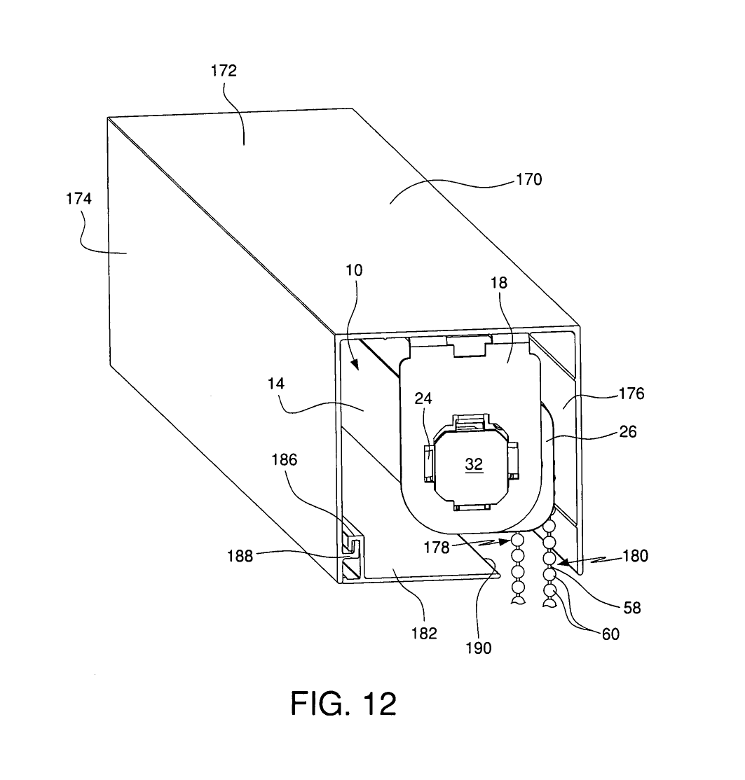

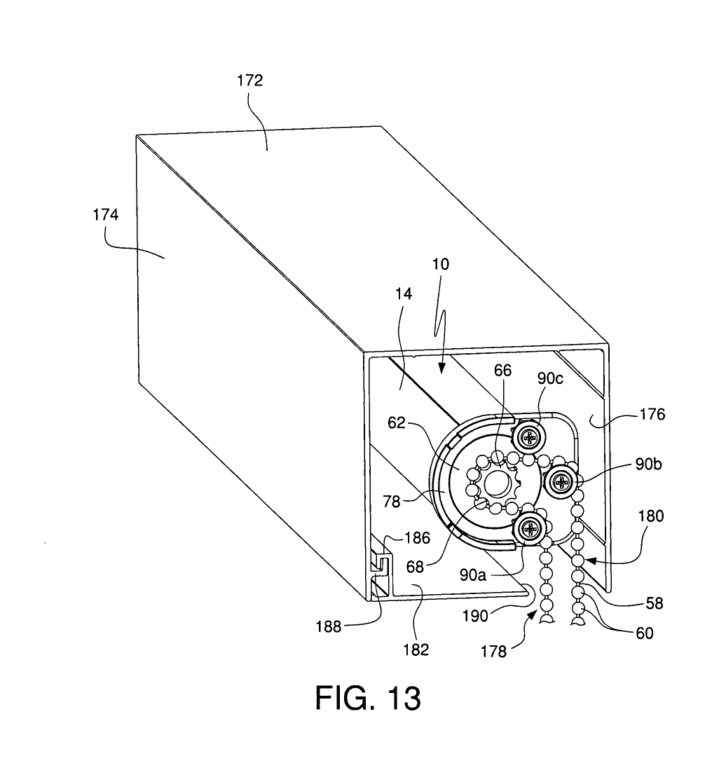

Referring to FIGS. 12 and 13, the manual roller shade 10 is shown secured to the brackets 18 and the mounting channel 170 in a third mounting configuration. The manual roller shade 10 is attached to the brackets 18 such that the shade 10 is rotated ninety degrees in a counter-clockwise direction in the third mounting configuration from the orientation of the shade 10 in the first mounting configuration of FIGS. 8 and 9. As shown, the L-shaped flange 188 is located on side wall 174 in the third mounting configuration and the J-shaped support flange 186 of bottom panel 182 is received by support flange 186 to support the bottom panel 182 such that a narrowed opening 190 is defined between the bottom panel 182 and side wall 176.

Referring to FIG. 13, the beads 60 of the drive chain 58 in the third mounting configuration engage the sprocket 66 about a left-hand side of the sprocket 66 (from the point of view shown in FIG. 13). As also shown, the drive chain 58 is directed laterally from the sprocket 66 from both the top and the bottom of the sprocket 66 towards side wall 176. The drive chain 58 is directed about each of the guide wheels 90a and 90b such that the beads 60 of the drive chain 58 engage the outer peripheries of the guide wheels 90a and 90b and the first and second hanging portions 178, 180 of the drive chain 58 hang downwardly from the guide wheels 90a and 90b, respectively, through the narrowed opening 190.

Although not shown, the construction of the manual roller shade 10 provides for a fourth mounting configuration in which the roller shade 10 is rotated an additional ninety degrees in the clockwise direction from that shown in FIG. 11. As should be understood, the opposite sides of the drive chain 58 in the fourth mounting configuration would be directed upwardly from the sprocket 66, wrap around the guide wheels 90a and 90c, and then be directed downwardly.

The chain guide system of the present invention, therefore, provides the ability to mount the roller shade optimally in one of multiple orientations without requiring additional or different hardware. This desirably simplifies installation and reduces the inventory that must be maintained, thereby reducing costs and limiting delays in installation. As shown, the chain guide wheels 90a, 90b, 90c are spaced from each other in a triangular configuration. The spacing between the guide wheels, however, is not critical but should be sufficient to provide desired separation between the opposite portions of the drive chain 58 that are dropped from the guide wheels in the various configurations described above. The spacing between the guide wheels 90a, 90b, 90c should also be selected to drop the chain 58 in a position specifically chosen so as to avoid obstacles or to improve performance as determined by other aspects of the shade assembly or the installation.

In addition, the mounting flexibility provided by the present invention desirably eliminates the need for notching of fascia or other top treatments to provide for chain drop. Such notching increases manufacturing/installation costs and is not aesthetically pleasing in appearance. Preferably, the components of the clutch mechanism 12 that are contacted by the drive chain 58, such as the sprocket 66 and the guide wheels 90a, 90b, 90c are made soft, low friction materials. Such construction desirably limits noise generated by the parts as the drive chain beads 60 move into and out of contact with these components and also limits drag on the drive chain 58.

Other prior manual shades incorporate deflectors, instead of notching, to provide for chain drop. This option, however, undesirably increases input force as discussed above by substantially increasing drag forces. Such manual shades also tend to be noisier and do not operate in a smooth, consistent, manner.

The manual roller shade 10 of the present invention is adapted to vary drop position of the drive chain 58 depending on the installation orientation (e.g., to avoid fascia). The present invention accomplishes this without added drag and without increased size. The present invention also provides the desired benefits in a relatively inexpensive manner while at the same time improving the performance of the clutch mechanism 12.

### Universal Hardware for Mounting Manual Shades and Motorized Shades

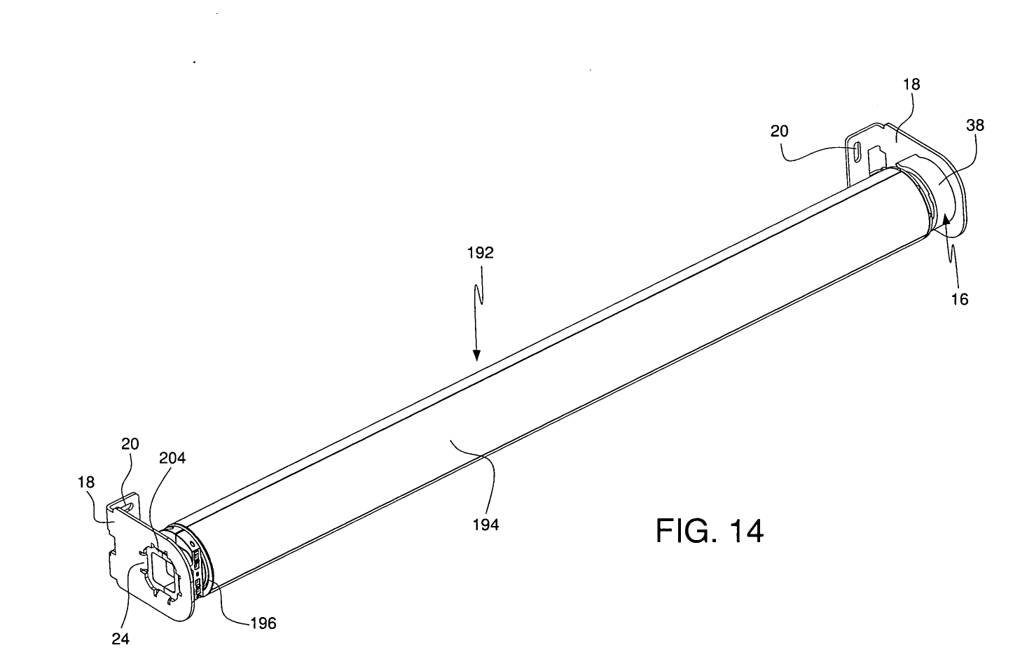

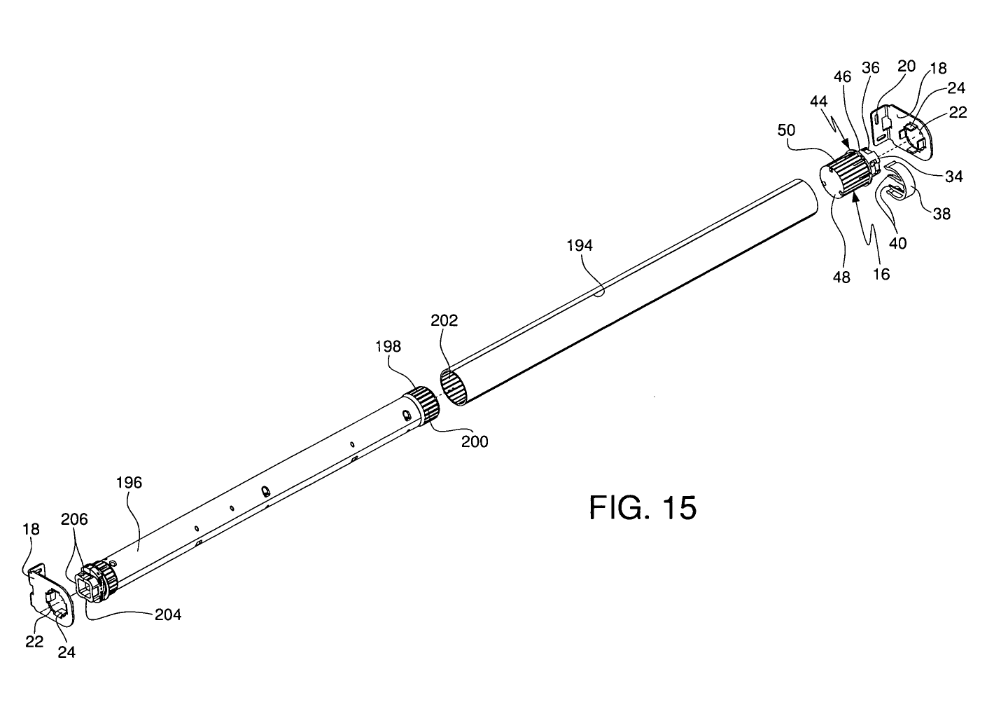

Referring to FIGS. 14 and 15, there is shown a motorized roller shade 192 including a drive motor 196 according to an exemplary embodiment of the invention. As described below, the motorized roller shade 192 includes brackets 18 and an idler assembly 16 that is identical to the brackets 18 and idler assembly 16 of the above-described manual roller shade 10 of FIGS. 1-13. The roller shade mounting system provides for simplified upgrade of an installed manual roller shade

Referring first to the idler end of the motorized shade 192, which is located on the right-hand side of the motorized shade 192 in the views shown in FIGS. 14 and 15, the idler assembly 16 includes a mount portion 34, cover 38 and tube end fitting 44 that are identical to those of the manual roller shade 10. Converting a manual roller shade installation to a motorized roller shade installation, therefore, would merely require removal of the manual roller shade 10 from brackets 18, removal of the clutch assembly 12 from the roller shade, and replacement of the clutch assembly with the motor for the motorized roller shade installation. Such an upgrade from the manual roller shade to a motorized roller shade, therefore, could be accomplished without the need for replacement or modification of the brackets 18 and without the need to remove the idler assembly 16 from the idler end of the roller tube. The upgrade is achieved simply by removing the manual drive system from the input end of the roller shade and by replacing the manual drive system with the motor of the motorized roller shade adapted for receipt by the bracket. Thus, all that is needed to accomplish the upgrade is the motor. The invention provides a completely shared system that includes brackets, roller tube, idler end assembly, fabric, hembar, fascia, top/back, pocket, flap, flap hanger, end-caps, etc. No modification is needed for any of these shared features. The shared features according to the present invention, therefore, desirably saves cost and time compared to conventional upgrade from a manual shade installation to a motorized shade installation.

Referring to the motorized end of the motorized roller shade 192, which is on the left-hand side of the motorized roller shade 192 in FIGS. 14 and 15, the drive motor 196 is elongated for receipt within the interior of roller tube 194. The drive motor includes a drive member 198 having exterior formations 200 adapted to engage internal formations 202 on the roller tube 194 to transfer rotation of the drive member 198 into rotation of the roller tube 194. Such internal drive motors are known and no further description is required. The motorized roller shade 192 includes a bracket mount portion 204, which is located at an end of the drive motor 196 to extend from an adjacently located end of the roller tube 194 when the drive motor 196 is positioned within the interior of the roller tube 194 to drive the roller tube 194. The bracket mount portion 204 includes notches 206 about a periphery of the bracket mount portion. The notches 206, in a similar fashion as the notches 36 in the bracket mount portion 34 of idler assembly 16, receive the tabs 24 of the associated bracket 18 of the universal mounting system.

Regarding the above-described brackets 18 that are identical in construction and adapted for mounting either the manual shade 10 or the motorized shade 192, several constraints were important in configuring the bracket. For a manual roller shade, the mounting system, and therefore the hardware, is traditionally designed with an entirely different set of constraints than that for a motorized shade. The constraints associated with a manual shade include use of a chain, the drop location for the chain, and the deflection of the drive chain. The constraints associated with a motorized shade include the use of buttons (e.g., for programming, setting limits, etc.), light-emitting diodes (LEDs) (e.g., for status and troubleshooting feedback), user access to the buttons and visibility of the LEDs, and the location of a printed circuit board (PCB) and wires. General constraints applicable to both manual shades and motorized shades include manufacture/assembly, shade fabric gaps, spring-pin installation style, identical bracketing, overall size, and systems for retaining the shade.

The size of the aperture 22 of bracket 18 must be sized to receive the idler end assembly 16 such that the tabs 24 about the aperture 22 of bracket 18 fit within the inner diameter (ID) of the bearing idler sleeve 41. This is necessary for providing the above-described compression feature for the idler end assembly 16. If the tabs 24 do not fit within the sleeve ID, the spring 45 will not compress sufficiently to allow for insertion of the opposite drive side of the roller shade into the opposite bracket 18.

Referring to FIG. 1, the bracket mount portion 32 of the clutch mechanism 12 is dimensioned to fit within the aperture 22 of the bracket similar to the bracket mount portion 34 of idler end assembly 16 such that the tabs 24 of bracket 18 are received in openings 30 of back cover 26. As shown in FIG. 3, however, the input wheel 62 is preferably sized such that the sprocket 66 of the input wheel 62 is smaller than the aperture 22.

### Optimized Force Reduction

In a manual roller shade, the force that must be applied to the drive chain to raise or lower the shade fabric (i.e., the “input force” or the “Force In”) has three components. The three components of the input force include a shade force, an input drag, and a clutch drag. The shade force component of the input force represents a contribution of the weight of the shade fabric as converted through the clutch into a force at the input chain. The conversion of the shade weight through the clutch is dependent on roller tube diameter, diameter of the input wheel (i.e., the sprocket), and the gear train (i.e., the gear ratio). The input drag component of the input force represents the drag forces generated on the input wheel sprocket and the drive chain. As input force increases, the input drag increases. The clutch drag represents drag forces in the clutch anywhere other than the input wheel sprocket and chain and is a function of the gear ratio, the diameter of the input wheel sprocket, the fabric weight and the frictional characteristics of the clutch. As the fabric weight increases, the clutch drag increases.

Obviously, the most direct way to reduce input force is to reduce the fabric weight. Assuming fabric weight is a constant, however, other variables must be controlled to reduce input force. To reduce the shade force component, the gear ratio can be increased. However, other constraints typically limit the gear ratio that is utilized.

Input drag includes contributions from a number of interacting surfaces associated with the input wheel sprocket and the drive chain and is dependent on coefficients of friction and normal forces that are directly proportional to the input force. The drag of the chain is increased substantially when the chain is deflected around obstacles such as fascia or other top treatments. In the above-described manual roller shade 10 according to the invention, the use of rotating guide wheels 90a, 90b, 90c to deflect the chain substantially reduces chain drag compared to the use of fixed deflector surfaces for example. The drag from the input wheel sprocket is reduced by lowering coefficient of friction through material selection (e.g., by using low friction engineering polymers).

Clutch drag includes contributions from multiple sources most principally from brake drag, bearing drag in the clutch assembly, and bearing drag at the idler end. The effect of clutch drag can be reduced by increasing gear ratio. However, as discussed above, this is limited by other considerations. Brake drag can be minimized by material selection for friction reduction and geometry of the brake component parts (e.g., brake input and brake springs). Bearing drag at the idler end and in the clutch assembly is preferably reduced by including a ball bearing assembly. Bearing drag can also be reduced further by component geometry and material selection.

The manual shade 10 of the present invention optimizes reduction of force based on other practical constraints. Two main constraints include clutch size and chain travel. As shown in the figures, a portion of the clutch mechanism 12 is sized to fit within the interior of the roller tube 14. Thus, the clutch cannot be enlarged beyond this constraint. The second main constraint is the chain travel versus fabric travel. For a jointed chain (i.e., a drive chain having a joint piece not adapted to travel about the sprocket), the practical maximum chain travel is no more than twice the fabric travel (i.e., the “fabric drop”). This assumes that the chain extends from the roller shade approximately the same distance as the fabric drop. Although, the chain could be made longer than the fabric drop, this is not desirable.

The chain travel constraint can be used to optimize force reduction as follows. Work is equal to force applied multiplied by distance (i.e., W=F·d). In shade terms, work is represented by input force times the chain travel (i.e., W_{CHAIN}=F_{CHAIN}·d_{CHAIN}) and also by fabric weight times fabric travel (i.e., W_{FABRIC}=F_{FABRIC}·d_{FABRIC}). For a given shade, the above work terms are equal and fixed (i.e., W_{CHAIN}=W_{FABRIC}). Thus, using a maximum chain travel equal to twice the fabric travel (i.e., d_{CHAIN}=2·d_{FABRIC}) will provide minimum input force (i.e., F_{CHAIN}=F_{FABRIC}·d_{FABRIC}/d_{CHAIN}=½·F_{FABRIC}). As should be understood from the above work relationships, the ratio of chain travel to fabric travel must equal the ratio of fabric weight to input force (i.e., d_{CHAIN}/d_{FABRIC}=F_{FABRIC}/F_{CHAIN}). This ratio, which represents the optimum gear ratio GR, therefore, ideally should be 2:1.

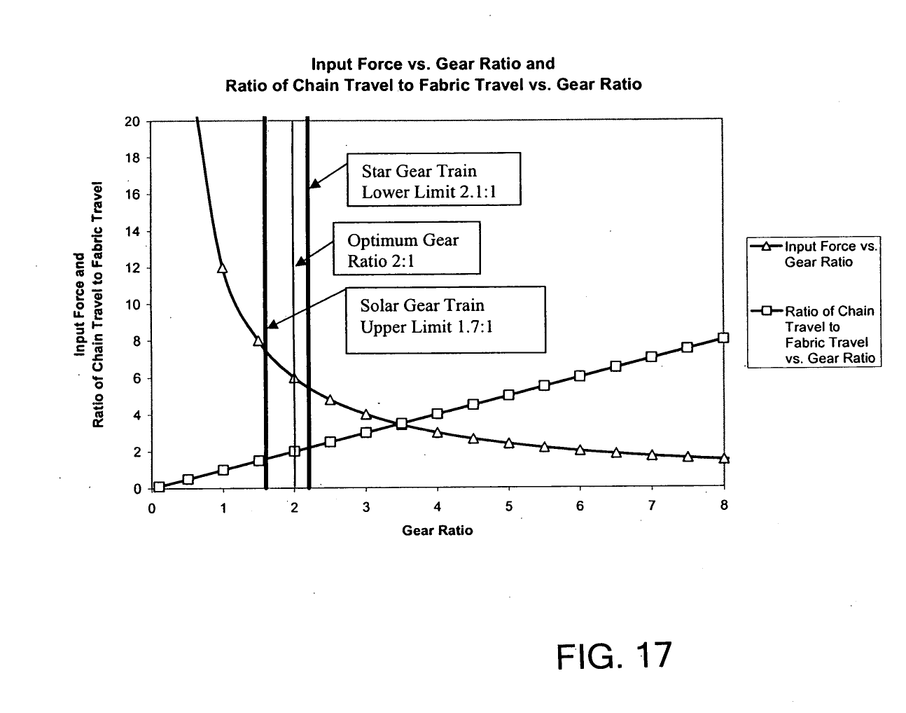

As should be understood, the desired gear ratio of 2:1 is for a jointed-chain (i.e., a chain that is not intended to the be driven in continuous fashion about the sprocket). For a drive chain adapted to be driven in continuous fashion, one could reduce the input force F_{CHAIN} as far as desired simply by increasing the gear ratio. FIG. 17 shows a curve of the input force F_{CHAIN} as a function of the gear ratio GR (i.e., F_{CHAIN}=F_{FABRIC}/GR). A curve of the ratio of the chain travel d_{CHAIN} to the fabric travel d_{FABRIC} as a function of the gear ratio GR is also shown and is a straight line since GR=d_{CHAIN}/d_{FABRIC}. A practical “optimum” condition for a continuous chain would be a gear ratio GR located at the intersection between the two curves (i.e., a gear ratio of approximately 3.5:1). In general, such a gear ratio would represent a good balance between force and travel ratio from a mathematical standpoint. It should be understood, however, that the force reduction system provided by the present invention, which is described in greater detail below, is not limited in use to manual roller shades having jointed chains (i.e., to achieve a gear ratio of 2:1). The force reduction system of the present invention described herein for a jointed chain would be applicable to any manual roller shade (e.g., one having a continuous chain) to obtain an effective gear train ratio of choice.

Epicycle gear trains are well known in a variety of different types of products and are ideal for providing compact, robust and reliable gear reduction with relatively simple parts and low cost. They provide far greater strength at a given diameter as compared to other types of gear trains. Epicycle gear trains include planetary, solar, and star trains each having a sun gear, planetary gears and a ring gear. In a planetary epicycle gear train, the ring gear is stationary while the sun gear and a planetary carrier are rotated. In a solar epicycle gear train, the sun gear is fixed while the ring gear and planetary carrier are rotated. In a star epicycle gear train, the planet carrier is fixed while the sun gear and ring gear are rotated. The manual roller shade 10 of the present invention incorporates a star epicycle gear train.

The gear reduction that is provided in the different types of epicycle gear trains depends on which component is used as the input and which is used as the output. Planetary epicycle gear trains can easily and practically provide gear ratios between 3.1:1 to 12.1:1 with the smaller ratios being more difficult as the ring gear diameter is made smaller. Solar epicycle gear trains are adapted to provide gear ratios between 1.2:1 to 1.7:1 with the higher ratios being more difficult as the ring gear diameter is made smaller. Star epicycle gear trains are adapted to provide gear ratios between 2.1:1 to 11.1:1 with the lower end being more difficult as the ring gear diameter decreases. It should be understood that the above ranges of gear ratios are considered by those skilled in the art as practical limits for simple epicycle gear trains. Gear ratios outside of the specified ranges could be achieved. However, to do so requires that undesirable sacrifices be made to cost, performance, each of manufacture/assembly and/or strength.

Referring to FIG. 17, the area between the two vertical lines (i.e., gear ratios between 1.7 and 2.1) represents the range of gear ratios that are outside of the practical ranges of gear ratios described above for standard epicycle gear trains. As shown, the desired 2:1 gear ratio described above is located within the area that is outside the practical ranges for standard epicycle gear trains.

As described above, the optimum gear ratio based on balance of chain travel and force reduction is 2:1 for a jointed chain. Since this ratio is not practical with a standard epicycle gear train, the manual roller shade 10 of the present invention includes a component sizing arrangement having the effect of trading off gear ratio otherwise achievable with the star gear train such that an effective gear train ratio of 2:1 is achieved. More particularly, the gear ratio trade off is achieved by selecting the input wheel sprocket diameter such that the ratio of the sprocket wheel diameter to the roller tube diameter (i.e., a “sprocket ratio”) creates an overall combined gear ratio of 2:1. In other words, some of the mechanical advantage associated with the star epicycle gear train is offset by the sprocket ratio to achieve the desired gear ratio of 2:1. As described above, the force reduction system of the present invention can be applied to any manual roller shade to achieve a desired effective gear ratio. However, for a jointed chain, the desired ratio is 2:1 for the reasons described above.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A clutch mechanism for a manual roller shade having a roller tube adapted for winding receipt of a flexible shade fabric, the roller tube having a diameter, the clutch mechanism comprising:
a rotatably supported sprocket adapted to receive a drive chain for rotation of the sprocket in response to application of an input force to the drive chain, the sprocket having a diameter;
an output member adapted for engagement with the roller tube; and
a gear train coupled between the sprocket and the output member for transmitting rotation of the sprocket to rotation of the output member, the gear train including a sun gear, a plurality of planet gears rotatably mounted on a planet carrier and meshingly engaging the sun gear, and a ring gear meshingly engaging the planet gears, the sun gear and the ring gear rotating during actuation of the gear train while the planet carrier is held against rotation,
wherein the sprocket, the gear train, the output member and the roller tube define an effective gear train ratio of approximately 2:1.

2. The clutch mechanism of claim 1, wherein a sprocket ratio is represented by the ratio between the diameter of the sprocket and the diameter of the roller tube, and wherein the sprocket ratio is selected so as to offset mechanical advantage associated with the gear train to provide the effective gear train ratio of approximately 2:1.

3. The clutch mechanism of claim 2, wherein the gear train has a gear ratio of between 2.1:1 and 11.1:1.

4. The clutch mechanism of claim 1 further comprising a brake mechanism for preventing back-driving of the gear train by the output member, the brake mechanism including a brake input engaged to the ring gear to rotate with the ring gear and at least one brake spring, the brake spring having a coiled body portion and outwardly directed end tangs at opposite ends of the body portion, the brake input received within an interior of the output member and having a side opening receiving the end tangs of the brake spring such that each end tang is located between an edge of the brake input and an inner surface of the output member.

5. The clutch mechanism of claim 4, wherein the coiled body portion of each brake spring is received onto a portion of the planet carrier for engagement between the brake spring and the planet carrier.

6. The clutch mechanism of claim 1, wherein the sprocket is carried by an input wheel including a disc.

7. The clutch mechanism of claim 6, wherein the sun gear of the gear train is secured to a sun gear shaft, and wherein the sun gear shaft is received by the input wheel opposite the sprocket such that the sun gear rotates with the sprocket.

8. The clutch mechanism of claim 1, wherein the drive chain includes beads and wherein the sprocket defines rounded bead notches about an outer periphery of the sprocket adapted for receiving the drive chain beads.

9. The clutch mechanism of claim 1 further comprising a drive chain guide system including a plurality of chain guide wheels rotatably supported and arranged to receive the drive chain from the sprocket.

10. The clutch mechanism of claim 9, wherein the drive chain includes beads and wherein each chain guide wheel defines rounded bead notches about an outer periphery of the chain guide wheel for receiving the beads of the drive chain.

11. The clutch mechanism of claim 1 further comprising a cover removably engaged to the planet carrier such that the sprocket is located between the cover and the planet carrier.

12. The clutch mechanism of claim 11 further comprising a sprocket support post and a chain guide rail carried by the cover, the sprocket defining a central aperture receiving the sprocket support post for rotation of the sprocket on the support post, the chain guide rail arranged for receipt of the drive chain between the chain guide rail and the sprocket.

13. A manual roller shade comprising:
a roller tube adapted for winding receipt of a flexible shade fabric;
a rotatably supported sprocket;
a drive chain received by the sprocket for rotation of the sprocket in response to application of an input force to the drive chain;
a rotatably supported output member engaging the roller tube such that the roller tube rotates with the output member; and
a gear train coupled between the sprocket and the output member for transmitting rotation of the sprocket to rotation of the output member, the gear train including a sun gear, an outer ring gear, and a plurality of planet gears disposed between the sun gear and the outer ring gear,
wherein the sprocket, the gear train, the output member and the roller tube define an effective gear train ratio of approximately 2:1.

14. The manual roller shade of claim 13 wherein the planet gears are rotatably supported by a planet carrier, and wherein the gear train is a star epicycle gear train in which the sun gear and the ring gear rotate during actuation of the gear train while the planet carrier is held against rotation.

15. The manual roller shade of claim 13, wherein the gear train has a gear ratio of between 2.1:1 and 11.1:1 and wherein the effective gear train ratio is obtained by offsetting mechanical advantage associated with the gear train.

16. The manual roller shade of claim 15, wherein a sprocket ratio is represented by the ratio between the diameter of the sprocket and the diameter of the roller tube, and wherein the sprocket ratio is selected to offset the mechanical advantage associated with the gear train.

17. A chain guide system for a manual roller shade having an input sprocket adapted to receive a drive chain for applying an input force to actuate the manual roller shade, the chain guide system comprising:
a plurality of rotatably supported chain guide wheels spaced apart from each other to receive the drive chain from the input sprocket such that the chain guide wheels control where the chain is suspended from the manual roller shade.

18. The chain guide system of claim 17, wherein the plurality of chain guide wheels includes three chain guide wheels.

19. The chain guide system of claim 17 further comprising a chain guide rail arranged such that the sprocket is disposed between the chain guide rail and the chain guide wheels.

20. The chain guide system of claim 17, wherein the drive chain includes rounded beads and wherein each of the drive chain wheels defines rounded bead notches about an outer periphery of the drive wheel for receiving the drive chain beads.

21. The chain guide system of claim 17, wherein the drive chain wheels are adapted to guide the drive chain in a plurality of orientations for the drive chain wheels including first, second and third orientations, the second orientation being 90 degrees clockwise from the first orientation and the third orientation being 90 degrees counter-clockwise from the first orientation, and
wherein the plurality of chain guide wheels includes a first guide wheel, a second guide wheel and a third guide wheel, the chain guide wheels disposed in a triangular arrangement such that the drive chain respectively contacts the first and third guide wheels, the second and third guide wheels and the first and second guide wheels in the first, second and third orientations for the chain guide wheels.

22. The chain guide system of claim 21, wherein the second guide wheel is disposed below the input sprocket in substantially vertical alignment with the input sprocket in the first orientation of the chain guide wheels and in substantially horizontal alignment with the input sprocket wheel in each of the second and third orientations of the chain guide wheels.

23. The chain guide system of claim 21, wherein the first and third guide wheels are aligned with each other in substantially horizontal fashion in the first orientation of the chain guide wheels and are aligned with each other is substantially vertical fashion in each of the second and third orientations of the chain guide wheels.

24. The chain guide system of claim 17, wherein the chain guide wheels are rotatably supported by a carrier and the input sprocket is rotatably supported by a cover, the cover removably engaging the carrier such that the sprocket and chain guide wheels are located between the carrier and the cover.

25. The chain guide system of claim 17, wherein the chain guide wheels control the drive chain such that the drive chain applies only tangential loading to the input sprocket.

26. An input drive system for a manual roller shade for applying an actuation force to the manual roller shade for rotating a roller tube of the roller shade, the input drive system comprising:
a rotatably supported sprocket wheel;
a drive chain received by the sprocket for rotation of the sprocket in response to application of an input force to the drive chain; and
a plurality of rotatably supported chain guide wheels including a first guide wheel, a second guide wheel and a third guide wheel, the chain guide wheels disposed in a triangular arrangement such that the drive chain contacts two of the chain guide wheels in each of first, second and third orientations of the chain guide wheels in which the second orientation is 90 degrees clockwise from the first orientation and the third orientation is 90 counterclockwise from the first orientation.

27. The input drive system of claim 26, wherein the drive chain respectively contacts the first and third guide wheels, the second and third guide wheels and the first and second guide wheels in the first, second and third orientations for the chain guide wheels.

28. A method of replacing a manual roller shade with a motorized shade comprising:
providing first and second brackets each adapted to receive any one of an idler end assembly, an input end of a manual roller shade, and a motor of a motorized roller shade;
providing a manual roller shade having a manual drive unit located at an input end of the manual shade and an idler end assembly located at an opposite idler end of the manual shade, each of the manual drive unit and the idler end assembly adapted for receipt by the one of the brackets;
installing the first and second brackets at spaced locations of an installation site;
mounting the manual roller shade at the installation site such that the input end and idler end assembly of the manual roller shade are respectively received by the first and second brackets;
removing at least the input end of the manual roller shade from the first bracket at the installation site;
removing the manual drive unit from the manual roller shade;
replacing the manual drive unit with a motor for a motorized roller shade such that a motorized roller shade is created; and
mounting the motorized roller shade at the installation site such that the motor is received by the first bracket.

29. The method of claim 28, wherein the steps of removing the manual drive unit from the manual roller shade and replacing the manual drive unit with a motor for a motorized roller shade are performed at the installation site.

30. The method of claim 28, wherein the steps of removing the manual drive unit from the manual roller shade and replacing the manual drive unit with a motor for a motorized roller shade are performed without removal of the idler end assembly from the second bracket.

31. The method of claim 28, wherein the bracket includes an aperture adapted for receipt of a cooperatively formed end portion of any one of the idler end assembly, the input end of the manual roller shade, and the motor of the motorized roller shade.

32. The method of claim 31, wherein the bracket includes a plurality of projecting tabs spaced about the aperture, the projecting tabs adapted for receipt by notches defined by any one of the idler end assembly, the input end of the manual roller shade, and the motor of the motorized roller shade.

33. The method of claim 28, wherein the first and second brackets are substantially identical.

34. A roller shade mounting system adapted for alternate support of a manual roller shade and a motorized roller shade, the roller shade mounting system comprising:
a drive end bracket;
an idler end bracket;
an idler end assembly adapted for supported receipt by the idler end bracket;
an input assembly for a manual roller shade; and
a motor for a motorized roller shade,
each of the input assembly and the motor adapted for supported receipt by the drive end bracket to provide for removal of the input assembly from the drive end bracket at an installation and replacement of the input assembly with the motor such that the installation is converted from a manual roller shade installation to a motorized roller shade installation.

35. The roller shade of claim 33, wherein the manual roller shade installation can be converted to the motorized roller shade installation without replacement of the idler end assembly.

36. The roller shade mounting system of claim 34, wherein the drive end bracket is substantially identical to the idler end bracket.

37. The roller shade mounting system of claim 34, wherein each of the brackets includes an aperture and a plurality of projecting tabs spaced about the aperture, the projecting tabs adapted for receipt by notches defined by any one of the idler end assembly, the input assembly of the manual roller shade, and the motor of the motorized roller shade.
